(19) United States
(12) Patent Application Publication
(10) Pub. No.: US 2022/0155609 A1
(43) Pub. Date: May 19, 2022

(54) Method of adjusting camera shutter for maximum image stability

(71) Applicant: Luuk van Dijik, Zurich (CH)

(72) Inventor: Luuk van Dijik, Zurich (CH)

(21) Appl. No.: 16/950,089

(22) Filed: Nov. 17, 2020

(51) Int. Cl. G02B 27/64; G03B 9/58; H04N 5/353; H04N 5/235

(52) U.S. Cl. CPC G02B 27/646; H04N 5/2353; H04N 5/3532; G03B 9/58

(57) ABSTRACT

A method for camera image stabilization includes a method for detecting blur in an image; measuring vibration in an apparatus which is obtaining said image; syncing the vibration with the camera shutter; and compensating shutter speed based on the blur compensation.

### BACKGROUND OF THE INVENTION

### 1. Field of the Invention

The present invention relates to a method for image stabilization in one or more cameras mounted on an apparatus susceptible to vibration waves and capable of measuring vibration waves, i.e., an aircraft with an accelerometer or gyroscope with one or more photographing units which can detect vibrations (camera shake) of one or more frequencies and by using the detected vibrations as information for timing the camera shutter to enable a stable captured image.

### 2. Related Background Art

A conventional technology, which is the subject of the present invention, will now be described with reference to a case of an image stabilizing system for a device utilizing an image, such as a camera.

In modern photography, operations such as a determination of exposure and focusing which are important for photographing the image of a subject are usually automated. Therefore, a person which is not skilled in handling cameras rarely fails in operating the camera. However, there has not been available a system which is capable of automatically preventing image blur in photographing a subject resulting from the camera shake. Therefore, overcoming camera shake has depended upon the skill of the person who operates the camera. Accordingly, cameras capable of preventing the failure in photographing a subject due to the camera shake have been developed recently. In particular, a camera capable of preventing a failure in photographing a subject due to camera shake caused by a photographer has been researched and developed.

The camera shake takes place in the form of vibrations, the frequency of which is usually 1 Hz to 12 Hz. In order to take a picture without an image blur, even if the camera has been shaken at the time of the release of the shutter of the camera, vibrations generated due to the above-described camera shake must be detected and, for example, a compensating lens must be displaced in accordance with the detected value.

The camera shake can in principle be detected by a structure constituted in such a manner that a vibration detecting means, for detecting the angular acceleration and the angular velocity, and a calculating means, for electrically or mechanically integrating a detection signal so as to output the angular deviation, are mounted on the camera.

Since the camera shake takes place in the form of a particular frequency (by way of example, 1 Hz to 12 Hz), it might be considered sufficient for the camera shutter speed to integrate 1 Hz or higher frequencies into the frequency of obtaining images. However, a problem of low frequency noise will, in addition to a common problem of waiting time, will raise a fear that the image blur for each frame of a film cannot be sufficiently corrected in a case of a normal photographic mode (for example, a normal shutter speed of about 1/30 S).

In a case where an image stabilizing system of the type described above is mounted on a latest style camera including an automatic exposure mechanism and/or an automatic focusing mechanism, a user is disappointed with the system if the accuracy of stabilizing the image is unsatisfactory. By way of example, in high vibration environments such as helicopter aircraft, the violent shaking of the airframe may be hard to dampen mechanically, requiring very sensitive cameras or motion deblurring algorithms to get usable images. When the system tries to estimate translation through an algorithm, these violent rotations may lead to degraded precision of the image. As a result, a critical problem will arise in that the value and the estimation of the camera(s) are greatly reduced.

### SUMMARY OF THE INVENTION

To this end, an object of the present invention is to provide a method for image stabilization comprising: a method for detecting blur in an image; measuring vibration in an apparatus which is obtaining said image; syncing the vibration with the camera shutter; and compensating shutter speed based on the blur compensation. One embodiment of the invention comprises: blur detecting means for detecting a blur of an image; blur compensating means for compensating the blur of the image; control means for controlling the blur compensating means in response to the output from the blur detecting means; and varying means for changing the integration time constant of the control means, that of a high-pass filter or the gain of a control loop in accordance with shutter speed, whereby the image blur can be properly prevented in accordance with the shutter speed.

Another object of the present invention is to provide a camera image stabilizing apparatus according to the above-described structure in which the integration time constant of the control means, that of a high-pass filter or the gain of a control loop is reduced in accordance with the rise in the shutter speed, whereby the waiting time necessary to stabilize the image at the normal shutter speed or high shutter speed can be shortened and an influence of low frequency noise due to an integrating operation is prevented so that the image can be accurately stabilized.

A further object of the present invention is to provide a camera image stabilizing apparatus according to the above-described structure in which the integration time constant of the control means, that of a high-pass filter or the gain of a control loop is increased in accordance with the reduction in the shutter speed, whereby a further accurate photographic operation can be performed rather than shortening the waiting time when the shutter speed is relatively low, for example, 1/8 S or higher so that a photographic operation, while preventing the image blur, can be performed.

Other and further objects, features and advantages of the invention will be apparent from the following description.

Rigidly mount a 3 or 6 dof imu/accell/gyroscope to the camera sensor. For a given average frame rate, allow the system to delay or accelerate the opening of the shutter to a moment when the expected rotation of the sensor is minimal. Using the spectrum and the phases of the vibrations over the last few seconds, a prediction can be made for the moment of minimum motion.

In a helicopter this will very likely be a harmonic of the rotorfrequency, but across the airframe the peaks and throughs of the vibration will occur at different points in time so a SLAM system using multiple of those cameras should be ready to accept non-synced shutters. this is possible by accurately timestamping all cameras to a global clock, which in turn can be done by having the cameras send a high precision heartbeat signal with their internal clock, over a signal carrier like CAN or Ethernet that can reference this signal to their own clock to high precision.

The multi-camera SLAM then takes the motion estimate of the frame into account together with the relative position on the frame of each camera to do a smooth interpolation of the stream of incoming images from all cameras. in the case that the shutters do happen to be synchronized, this algorithm becomes identical to a synced shutter SLAM but it performs gracefully if the synced-shutter assumption does not hold.

The unit 24 is, for example, equipped with a programmable electronic computer and a memory containing the necessary instructions to perform a method of simultaneous localization and mapping, known under the acronym SLAM (Simultaneous Localization and Mapping). For details on these processes of localization and mapping simultaneously, the reader may refer to the introduction of the following article A1: Mr. Meilland and A I Comport, “We unifying key-frame and dense voxel-based visual SLAM have broad scales, “IEEE International Conference on Intelligence Robots and Systems, 2013, 3-8 Nov. in Tokyo.

In another variant, the template 16 is not necessarily built in advance during a learning phase. On the contrary, it may be constructed as and as the camera 80 is moved in the stage 6. The simultaneous construction of the camera path 80 and the mapping of the stage 6 is known by the acronym SLAM (Simultaneous Localization And Mapping). In this case, for example, camera images 80 are added to the model 16 as and when they are moving in the scene 6. Preferably, prior to adding a reference image to the model 16, celle- is treated to limit the RS deformation and/or MB as described in steps 72 and 74. in this stage 50 the variant and the device 20 are omitted

1. An image stabilizing apparatus for a camera, comprising:
(A) blur detecting means for detecting image blur;
(B) blur compensating means for compensating for image blur;
(C) control means for controlling said blur compensating means in response to an output from said blur detecting means; and
(D) varying means capable of changing in accordance with shutter speed, at least one of an integration time constant of said control means, an integration time constant of a high-pass filter, or the gain of a control loop.

2. An image stabilizing apparatus for a camera according to claim 1, wherein said varying means comprises means for reducing, in accordance with a rise in shutter speed, at least one of the integration time constant of said control means, the integration time constant of a high-pass filter, or the gain of a control loop.

3. An image stabilizing apparatus for a camera according to claim 1, wherein said varying means comprises means for enlarging, in accordance with a reduction in shutter speed, at least one of the integration time constant of said control means, the integration time constant of a high-pass filter, or the gain of a control loop.

4. An image stabilizing apparatus for a camera according to claim 1, wherein said varying means comprises means for changing the gain of a speed control loop.

5. An image stabilizing apparatus for a camera according to claim 1, wherein said varying means comprises means for changing the gain of a position control loop.

6. An image stabilizing apparatus for a camera according to claim 1, wherein said blur detecting means comprises means for detecting an angular velocity of an imaging optical system.

7. An image stabilizing apparatus for a camera according to claim 1, wherein said blur compensating means comprises a compensating optical means.

8. A camera comprising:
(A) blur detecting means for detecting image blur;
(B) blur compensating means for compensating image blur;
(C) control means for controlling said blur compensating means in response to an output from said blur detecting means; and
(D) varying means for changing, in accordance with shutter speed, at least one of an integration time constant of said control means, an integration time constant of a high-pass filter, or the gain of a control loop.

9. A camera according to claim 8, wherein said varying means comprises means for reducing, in accordance with rise in shutter speed, at least one of the integration time constant of said control means, the integration time constant of a high-pass filter, or the gain of a control loop.

10. A camera according to claim 8, wherein said varying means includes means for enlarging, in accordance with reduction in shutter speed, at least one of the integration time constant of said control means, the integration time constant of a high-pass filter, or the gain or a control loop.

11. A camera according to claim 8, wherein said varying means comprises means for changing the gain of a speed control loop.

12. A camera according to claim 8, wherein said varying means comprises means for changing the gain of a position control loop.

13. A camera according to claim 8, wherein said blur detecting means comprises means for detecting an angular velocity of an imaging optical system.

14. A camera according to claim 8, wherein said blur compensating means comprises compensating optical means.

15. An optical apparatus, comprising:
(a) vibration detecting means;
(b) vibration compensating means;
(c) control means for controlling an operation of said vibration compensating means in accordance with an output of said vibration detection means; and
(d) varying means for changing a vibration compensation characteristic of said vibration compensating means in accordance with shutter speed.

16. An apparatus according to claim 15, wherein said varying means changes a frequency range in which vibration is compensated for by said vibration compensating means.

17. An apparatus according to claim 16, wherein said varying means increases a lower limit of said frequency range in accordance with an increase in shutter speed.

18. An apparatus according to claim 16, wherein said varying means decreases the lower limit of said frequency range in accordance with a decrease in shutter speed.

19. An apparatus according to claim 15, wherein said optical apparatus performs a photographing function.

20. (canceled)

21. (canceled)

22. An apparatus according to claim 15, wherein said image blur prevention device includes an image blur compensating device that compensates for an image blur, and said varying means changes a frequency range in which vibration is compensated for by said vibration compensating device.

23. (canceled)

24. (canceled)

25. (canceled)

26. (canceled)
